(19) United States
(12) Patent Application Publication
(10) Pub. No.: US 2022/0411948 A1
(43) Pub. Date: Dec. 29, 2022

(54) ELECTROCHEMICAL LITHIUM EXTRACTION FOR BATTERY MATERIALS

(71) Applicant: Battelle Memorial Institute, Richland, WA (US)

(72) Inventors: Dongping Lu, Richland, WA (US); Robert M. Asmussen, West Richland, WA (US); Li-Jung Kuo, Sequim, WA (US); Jiangtao Hu, Shenzhen (CN)

(73) Assignee: Battelle Memorial Institute, Richland, WA (US)

(21) Appl. No.: 17/843,392

(22) Filed: Jun. 17, 2022

Related U.S. Application Data
(60) Provisional application No. 63/214,094, filed on Jun. 23, 2021.

(51) Int. Cl. C25C 1/02; H01M 4/04; C22B 3/42; C22B 26/12

(52) U.S. Cl. CPC C25C 1/02; H01M 4/0459; C22B 3/42; C22B 26/12; H01M 4/505

(57) ABSTRACT

A method that includes contacting a Li-containing aqueous liquid with a Li ion-selective membrane while simultaneously applying an electric field thereby extracting Li ions from the Li-containing aqueous liquid; and intercalating the extracted Li ions into a cathode material.

This application claims the benefit of U.S. Provisional Appl. No. 63/214,094, filed Jun. 23, 2021, which is incorporated herein by reference.

### STATEMENT OF GOVERNMENT SUPPORT

This invention was made with Government support under Contract DE-AC0576RL01830 awarded by the U.S. Department of Energy. The Government has certain rights in the invention.

### BACKGROUND

Conventional lithium mining carries high environmental costs, and requires extensive extraction operations and water in a dry land. Much of the lithium produced today is extracted from brine reservoirs; the salt-rich waters must first be pumped into a series of large evaporation ponds where solar evaporation occurs over a number of months. Another lithium mining pathway is extraction of lithium from spodumene, lepidolite, petalite, amblygonite, and eucryptite requires a wide range of processes. Because of the amount of energy consumption and materials required, lithium production from mining is a much more costly process than brine extraction, even though these minerals have a higher lithium content than the saltwater.

### SUMMARY

Disclosed herein is a method comprising:

contacting a Li-containing aqueous liquid with a Li ion-selective membrane while simultaneously applying an electric field thereby extracting Li ions from the Li-containing aqueous liquid; and

intercalating the extracted Li ions into a cathode material.

Also disclosed herein is a method comprising:

introducing a Li-containing aqueous liquid into a first chamber of a device, wherein the device comprises an anode, a cathode comprising electrolytic manganese dioxide, a Li ion-selective membrane between the anode and the cathode, the first chamber contacting the anode a first surface of the Li ion-selective membrane; and a second chamber contacting the cathode and a second surface of the Li ion-selective membrane, wherein the second chamber contains a nonaqueous liquid electrolyte;

applying an electric field to the device;

permitting Li ions to selectively flow through the Li ion-selective membrane and into the second chamber; and

intercalating the extracted Li ions into the electrolytic manganese dioxide.

Further disclosed herein is a device comprising:

an anode;

a cathode comprising electrolytic manganese dioxide;

a Li ion-selective membrane between the anode and the cathode;

a first chamber contacting the anode a first surface of the Li ion-selective membrane; and

a second chamber contacting the cathode and a second surface of the Li ion-selective membrane.

The foregoing will become more apparent from the following detailed description, which proceeds with reference to the accompanying figures.

### BRIEF DESCRIPTION OF THE DRAWINGS

FIGS. 1A-1E. Li extraction device and working mechanism. FIG. 1A. Schematic of the Li extraction device: the cathode and anode chambers are separated by LAGP SSE. Anode is stainless steel (SS) mesh immersed in Li-containing aqueous; cathode is EMD in contact with organic electrolyte. FIG. 1B. Voltage-capacity curves of EMD tested in Li∥EMD coin cells with different cut-off voltages. Electrolyte is 1M LiPF₆ in EC/EMC (w/w=3:7) and current density is 0.05 C (1 C=200 mA/g). FIG. 1C. Diagram of stable electrochemical window of water at pH=7 and working voltage window of different Li host materials. FIGS. 1D and 1E. Evolutions of the LAGP interfacial resistances in contact with 3M LiTFSI in EC/EMC (FIG. 1D) and 5M LiCl (FIG. 1E) during the first 22.5 h, the corresponding in-situ impedance were inserted separately.

FIGS. 2A-2H. Voltage profiles and structural characterizations of pristine and Li-intercalated EMD. FIG. 2A. Voltage profile of the Li extraction device with LAGP as separator. Electrolytes filled in the anode and cathode chambers are 5M LiCl in aqueous and 3M LiTFSI in EC/EMC. FIG. 2B. XRD patterns of the pristine (black curve) and Li-intercalated EMD (Red curve). FIGS. 2C-2F. TEM images of pristine EMD electrode (FIGS. 2C and 2D) and Li-intercalated EMD (FIGS. 2E and 2F). FIG. 2G. Li EELS spectra of pristine and Li-intercalated EMD. FIG. 2H. Voltage profiles of EMD in different mixed solutions (Li/Na and Li/Mg) to verify the selectivity of LAGP, the corresponding Li-ion concentrations vary from ppm scale to 2.5 M.

FIGS. 3A-3G. Cathode synthesis with the Li-extracted EMD and corresponding cell performance FIG. 3A. XRD patterns of the synthesized spinel LiMn₂O₄ and layered NMC333 cathodes. FIGS. 3B and 3C. SEM images of LiMn₂O₄ and NMC333. FIGS. 3D and 3F. Long-term cycling performance of the LiMn₂O₄ (FIG. 3D) and NMC333 (FIG. 3F), which were cycled at 0.1 C for the initial formation cycles, then charged and discharged at 0.33 C for the following cycles. (Color fill under the curve is the error bar from 2 parallel cycles) FIGS. 3E and 3G. Evolution of capacity-voltage profiles of LiMn₂O₄ (FIG. 3E) and NMC333 (FIG. 3G) in the first 300 cycles.

FIGS. 4A-4E. Battery materials production routes. FIGS. 4A and 4C. Route LiMn₂O₄—R1 (FIG. 4A) and LiMn₂O₄—R2 (FIG. 4C) to recover Li from seawater and produce LMO material. FIGS. 4B, 4D. Route NMC-R1 (FIG. 4B) and NMC-R2A/B (FIG. 4D) to recover Li from seawater and produce NMC material. FIG. 4E. Commercial process for NMC battery material production.

### DETAILED DESCRIPTION

Disclosed herein are methods and devices for high-efficient Li recovery from unconventional Li resources, (e.g. high salt waters/seawater) for direct low-cost Li battery materials manufacturing, bypassing the need for costly post-recovery processing using current methods.

In one configuration, coupled loops perform electrochemical Li extraction from salt waters and insert Li into the low-cost, transition-metal-oxide Li host structure materials. The harvested Li-contained host materials can then be used directly for high-energy Li battery cathode production, providing a low-cost Li source without the need for multiple processing steps. The proposed technology is generic and applicable to different high-salt waters such as seawater, brines and Li-recycle solutions, and industry wastes.

The Li extraction device disclosed herein includes an anode, a cathode comprising a manganese-containing material (e.g., electrolytic manganese dioxide (EMD)), a Li ion-selective membrane between the anode and the cathode, a first chamber contacting the anode a first surface of the Li ion-selective membrane, and a second chamber contacting the cathode and a second surface of the Li ion-selective membrane.

The anode may be made from, for example, stainless steel, nickel, titanium, tungsten, carbon, or graphite. In certain embodiments, the anode is made from corrosion-resistant metal(s) or alloy(s).

The cathode may be EMD or other oxides in a form of MOₓ, or fluorides in a form of MF_{y}, or sulfides in a form of MS, where M=Ti, V, Cr, Mn, Fe, Co, Ni, Cu, Zn, Zr, Nb, Mo, Si, Ge, Sn, Pb, P, As, Sb; 0≤x≤4; 0≤y≤6; 0≤z≤4.

The electrolytic manganese dioxide (EMD) constituting the cathode may be in the form of a film, powder, slurry or dispersion. The EMD may reside on a support structure, or be a free-standing film, or a dispersion in liquid. In certain embodiments, the EMD may be provided in a cartridge, where EMD is mixed with conductive carbon materials and dispersants. This EMD cartridge is flowable and electronic conductive.

An organic electrolyte is also provided on the cathode side of the device. The organic electrolyte may be a nonaqueous liquid electrolyte that is contained in the second chamber and that is in contact with the electrolytic manganese dioxide substrate. In certain embodiments, the nonaqueous liquid electrolyte includes at least one active salt and at least one solvent. Illustrative active salts include lithium bis(fluorosulfonyl)imide (LiFSI), lithium bis(trifluoromethanesulfonyl)imide (LiTFSI), lithium bis(pentafluoroethanesulfonyl)imide (LiBETI), lithium bis(oxalato)borate (LiBOB), LiPF₆, LiAsF₆, LiBF₄, LiCF₃SO₃, LiClO₄, lithium difluoro oxalato borate (LiDFOB), LiI, LiBr, LiCl, LiSCN, LiNO₃, LiNO₂, and Li₂SO₄. Illustrative solvents include a carbonate (for example, propylene carbonate, diethyl carbonate, ethylene carbonate, dimethyl carbonate, or ethyl methyl carbonate, fluorinated carbonate), ether-based solvents (for example, dimethoxyethane, diglyme, dioxolane, tetrahydrofuran, dimethyl sulfoxide), or ester-based solvents like ethyl acetate. In certain embodiments, the active salt is present in the nonaqueous electrolyte in an amount of 0.1 mol/L to 20 mol/L, more particularly 0.5 mol/L to 5 mol/L.

A Li-containing aqueous liquid as a Li extraction source may be contained in the first chamber of the device. Illustrative Li-containing liquids include seawater, brine (e.g., a briny lake), an underground source of concentrated salt water, a Li-recycle solution, or an industry waste.

Illustrative Li ion-selective membranes include NASICON structure LiAB(PO₄)₃ (A=Al, Cr, Ga, Fe, Sc, In, Lu, Y, or La; B═Ge, Ti and Zr) e.g., Li_{1.5}Al_{0.5}Ge_{1.5}(PO₄)₃ (LAGP), perovskite (ABO3)-type lithium lanthanum titanate (LLTO) Li₃ₓLa_{1-3X}TiO₃ (0<x<0.16), LISICON structure Li₂₊₂ₓZn₁₋ₓGeO₄, Garnet structure Li₅La₃M₂O₁₂ (M=Ta, Nb) or substituted Garnets Li₆ALa₂M₂O₁₂ (A=Ca, Sr, Ba) and Li₅Ln₃Sb₂O₁₂ with different trivalent lanthanide cations (Ln=La, Pr, Nd, Sm, Eu).

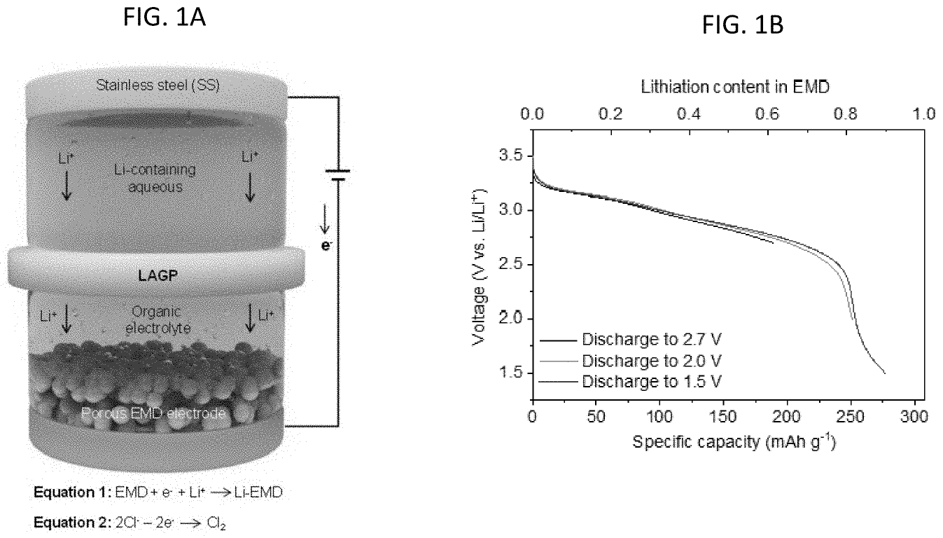

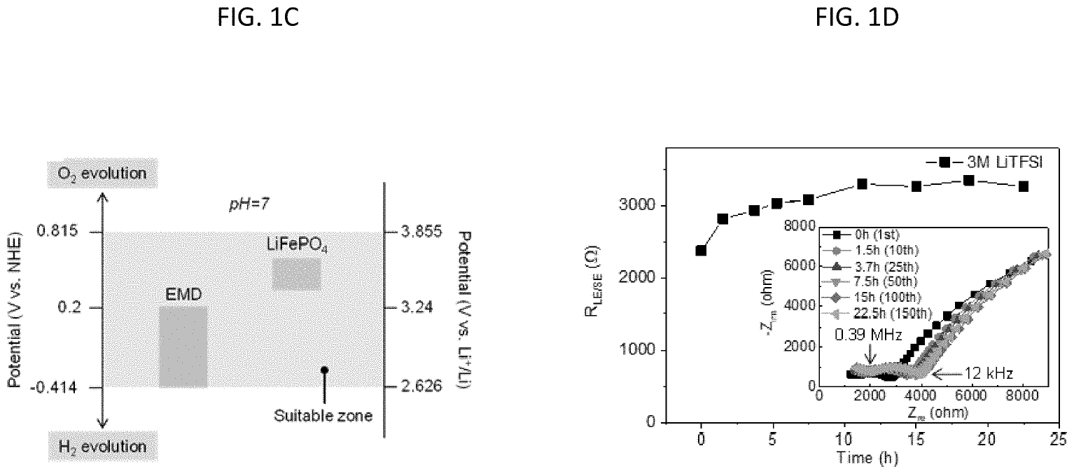

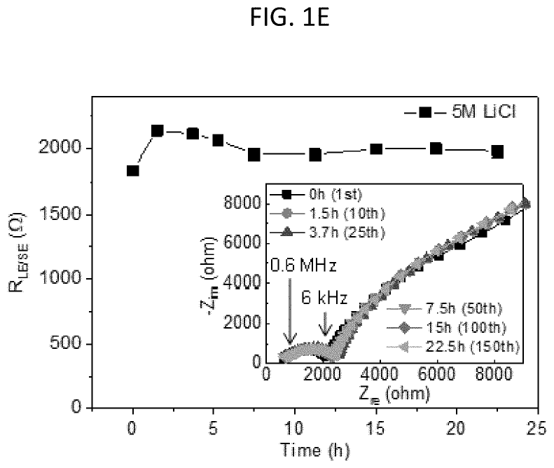

A schematic of an example of a Li extraction device is shown in FIG. 1A. The Li extraction cell was divided into anode and cathode chambers by LAGP membrane, and the chambers are filled with Li containing aqueous solution and nonaqueous electrolyte. Stainless steel (SS) is set in anode chamber, and the EMD was filled in the cathode chamber in a form of either processed film or powders. When electric field is applied, current flow will be generated and sustained by the anodic and cathodic reactions and the ion transportation through the LAGP membrane and both chambers. Driven by the electric field, Li ions in the anode chamber will pass through the LAGP membrane and intercalate into the EMD in the cathode chamber, forming Li-EMD (Equation 1 in FIG. 1A); the Cl in the anode chamber will be oxidized to Cl₂ for charge balance (Equation 2 in FIG. 1A). Through this circuit loop, Li ions will be continuously extracted out from a Li-containing feed stream at a speed controlled by applied current and be harvested in the EMD.

The applied electric field is from −2V to 5V vs. SHE (Standard Hydrogen Electrode).

The device has several design considerations. First, Li interaction voltage and capacity should fit the device design. As shown in FIG. 1B, EMD has a discharge plateau ranged from 3.25 V to 2.5 V vs. Li, which corresponds to 0.21 V-−0.54 V vs. SHE in a solution with pH=7. A large part of the electrochemical platform falls well into a stable electrochemical window of water. The Li intercalation capacity in EMD was verified in Li∥EMD coin cells by using the EMD electrode and nonaqueous electrolyte. Capacities of 188, 250 and 276 mAh g⁻¹ were obtained with discharge cutoff voltages of 2.7, 2.0, and 1.5 V vs. Li, respectively, confirming high capacity of the EMD (FIG. 1B). Second, stability of LAGP against aqueous solution and nonaqueous electrolyte should also be verified before device integration. Accordingly, bulk and interfacial stability of LAGP when contacted with either aqueous solutions (5M LiCl/H₂O) and nonaqueous electrolyte (3M LiTFSI/EC/EMC) were monitored by in-situ EIS using a hybrid cell design. Initially, the LAGP has some interactions with both solutions as proved by the variation of interfacial resistance (R_{LE/SE}) (FIG. 1D, 1E). In this experiment, the LAGP interface stabilized after exposure for 3.7 hrs in nonaqueous electrolyte (FIG. 1D) and 7.5 hrs in aqueous solution (FIG. 1E), which is due to the passivation of LAGP.

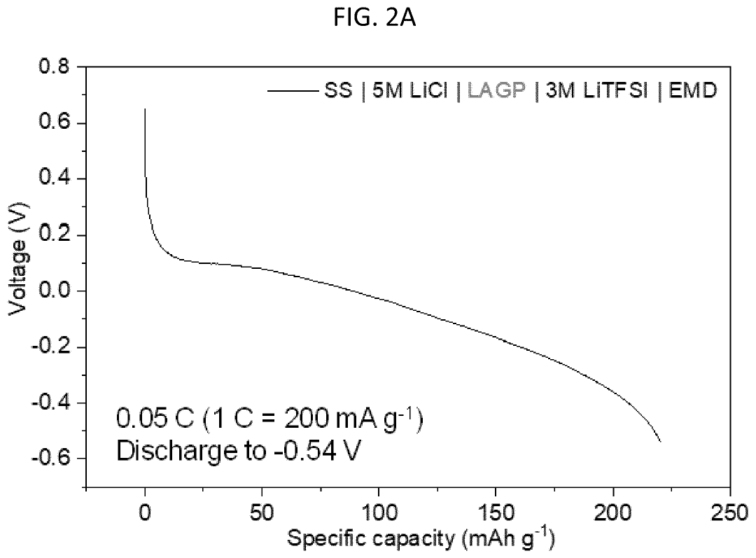

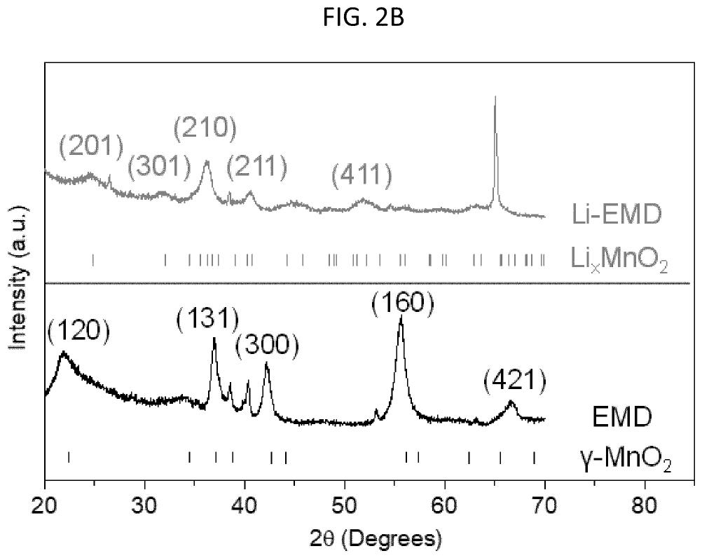

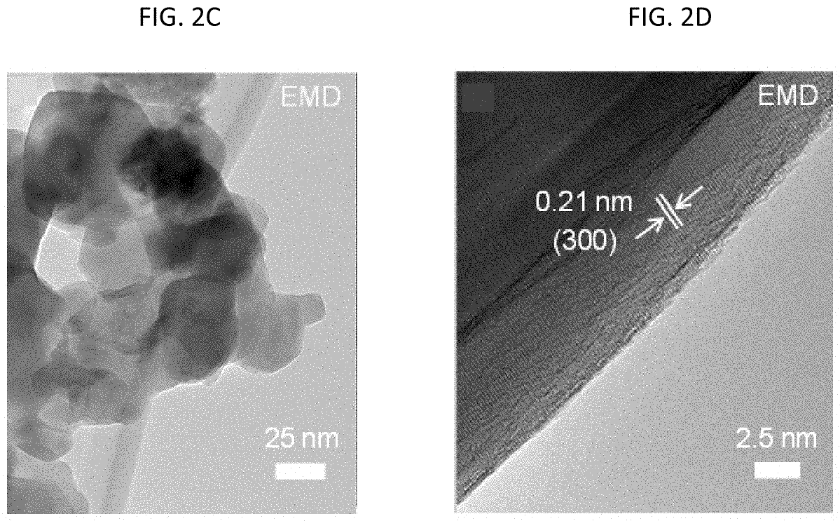

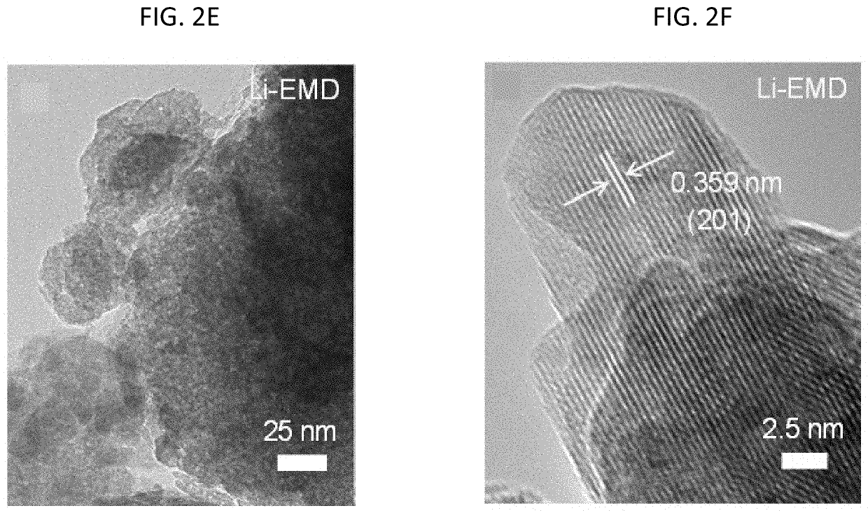

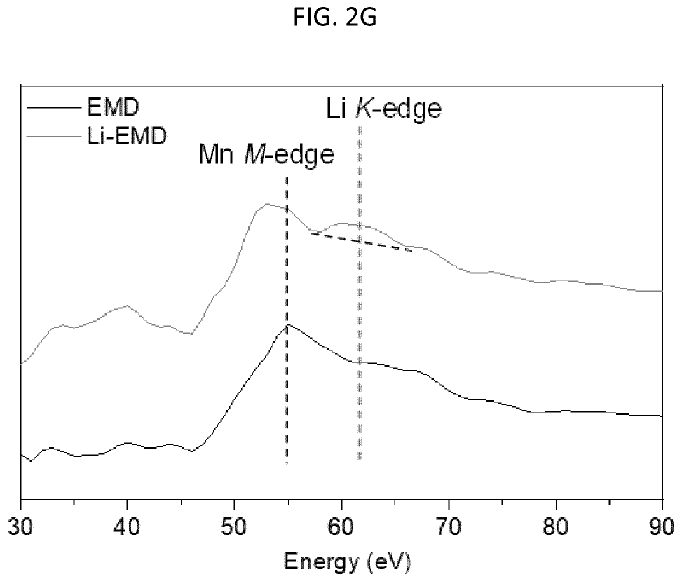

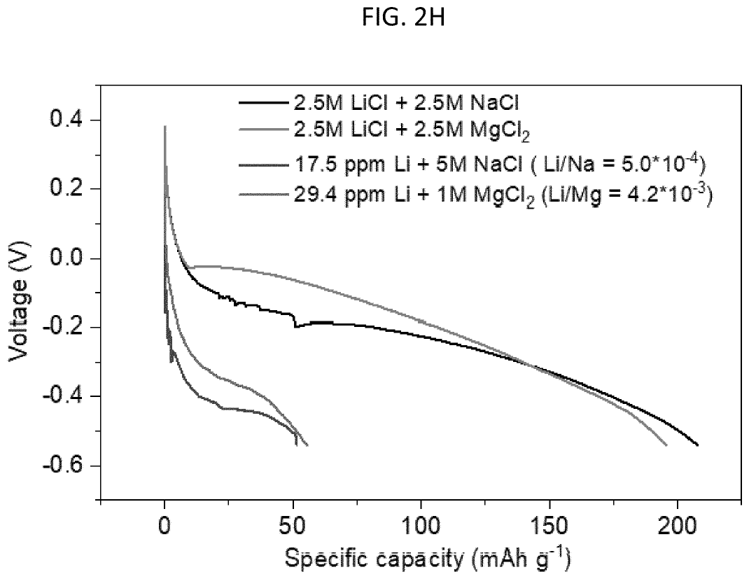

Li extraction was demonstrated by applying a constant current density of 10 mA/g_{EMD} (0.05 C). Due to limited volume of the anode chamber, Li solution with a relatively high concentration (5M LiCl/H₂O) was used to maximize utilization rate of the EMD. FIG. 2A exhibits voltage response upon Li intercalation. With more Li intercalates into EMD, the voltage curve decreases slowly at the beginning and drops quickly at the end, showing a plateau at around −0.1 vs. Ag/AgCl. The overall Li intercalation capacity is 220 mAh g⁻¹, meaning 0.772 mol of Li can be harvested by 1 mol EMD if all Mn ions are assumed at a 4+ valence. This is content with ICP-AES analysis result of the lithiated EMD, where the actual Li/Mn atomic ratio was measured to be 0.816, suggesting Li adsorption or exchange may coexist during the electrochemical extraction. To further confirm the Li intercalate into EMD crystal structure, XRD and high-resolution TEM characterization were performed on EMD before and after performing Li extraction. XRD results indicate that after extraction processing the EMD experiences a significant phase change and transforms to an orthorhombic LiₓMnO₂ structure (FIG. 2B). Such phase change is induced by reorganization of Mn local structures accompanying its valent change and Li intercalation, which is proved by HRTEM (FIGS. 2C-2F). It's well known EMD is predominately composed of γ-MnO₂, and the lattice fringes with d-spacing of 0.21 nm were clearly observed and assigned to the (300) plane of γ-MnO₂ (FIGS. 2C, 2D). After Li intercalation, new lattice fringes at d=0.359, which is a characteristic (201) plane of orthorhombic LiₓMnO₂, was observed (FIGS. 2E, 2F), which agrees well with XRD analysis (FIG. 2B). Moreover, in EELS spectra, a broad peak at around 61 eV was observed in Li-EMD (FIG. 2G), further confirming the existence of Li in the intercalated EMD.

The selective Li extraction from the aqueous Li stream and its successful intercalation into EMD are contributed by the nonaqueous electrolyte and LAGP membrane, which play a key role in by removing the interferences of H⁺ and other cations. Competition intercalations between Li⁺ and H⁺ were identified if an aqueous electrolyte (cathode chamber) is used. At the first glance, the Li extraction voltage-capacity curve in 3-electrode system was very similar to the behaviors in nonaqueous electrolyte (FIG. 2A) and the discharge capacity is 285 mAh/g, likely suggesting large-capacity Li extraction. However, XRD analysis and HRTEM images indicate totally different phase evolution pathway. Instead of forming Li-EMD, a phase of MnO(OH) appeared at the end of the process, which is similar to observations in primary MnO₂ batteries and ascribed to the H⁺ (or H₃O⁺) intercalation. The Li/Mn ratio measured by ICP-OES is as low as 0.018, suggesting H⁺ intercalation dominates the EMD conversion due to its smaller polarization and diffusion energy barrier. Decreasing H⁺ concentration or increasing Li⁺ concentration help to increase Li⁺ intercalation capacity to some extent, further confirming the competitions between the Li⁺ and H⁺. By using nonaqueous electrolyte, H⁺ co-intercalation can be fully eliminated. Meanwhile, the LAGP membrane functions effectively to prevent metal cations from co-intercalation into the EMD. If the Na⁺ and Mg²⁺ ions, typical cations in seawater, exist in the cathode chamber, they will co-intercalate into EMD crystal, causing ion impurities of final products and lowering Li extraction efficiency. With help of the LAGP membrane, those cations are fully blocked. As shown in FIG. 2H, with Li/Na=1 and Li/Mg=1, the EMD has very similar Li-extraction behaviors and no Na⁺ and Mg²⁺ can be detected in the final EMD. Even when the Li/M ratio was decreased to an extremely low level as those in seawater, the Li intercalation in EMD still occurs although higher polarization voltage and smaller capacities are observed, which are due to the limited total Li amount in such dilute solutions in comparison with the high mass loading EMD electrodes.

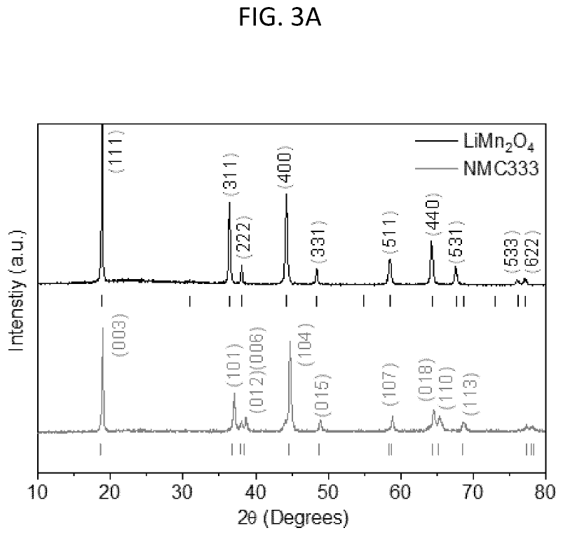

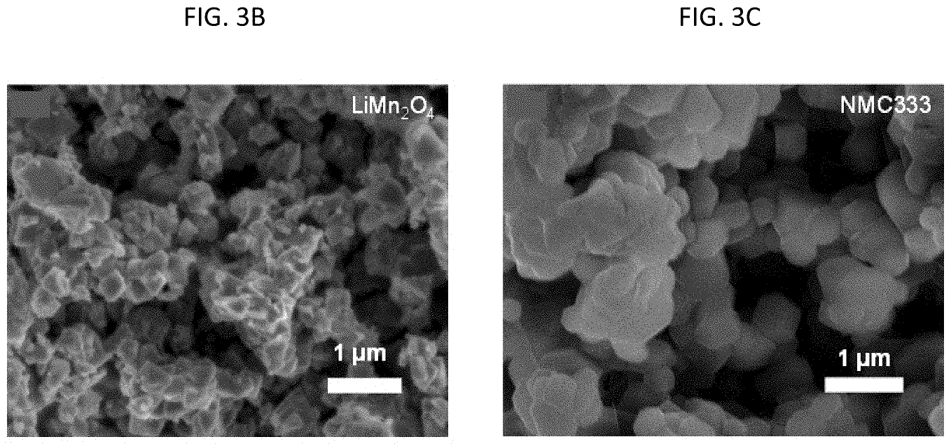

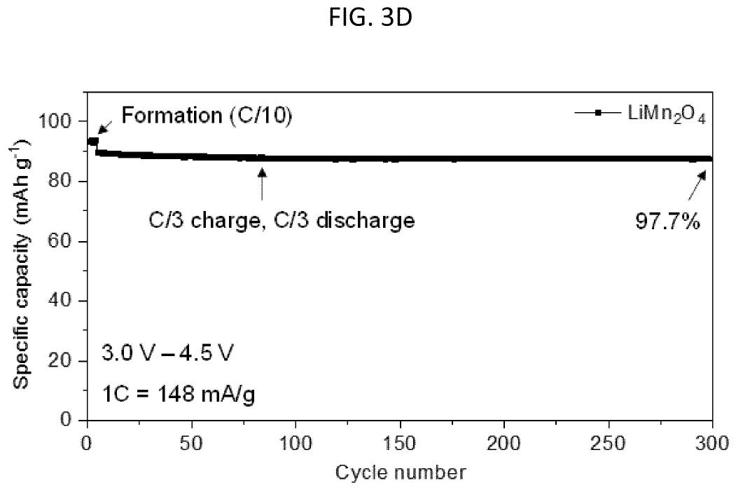

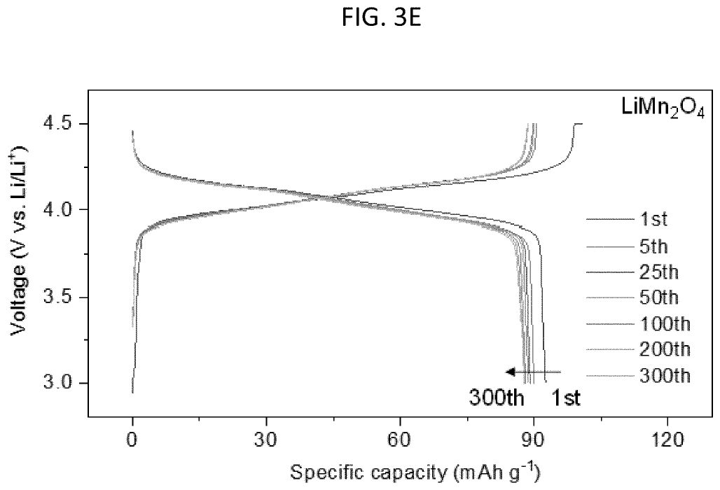

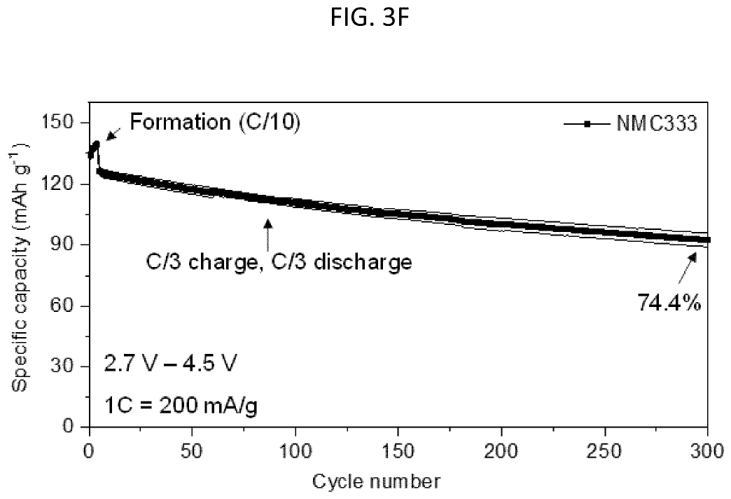

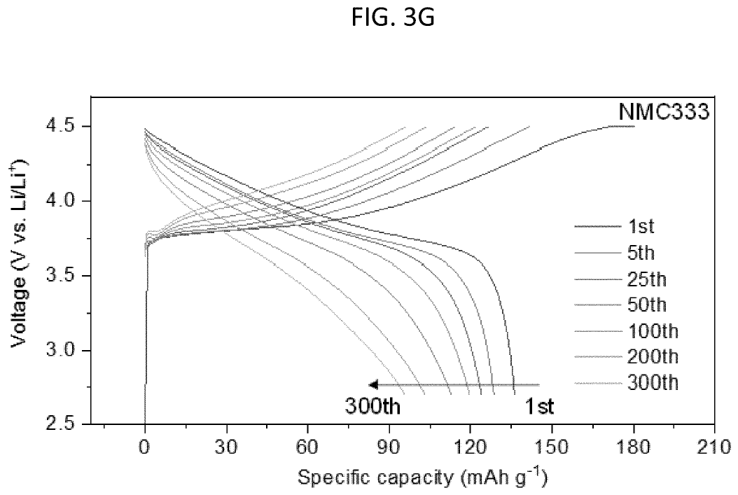

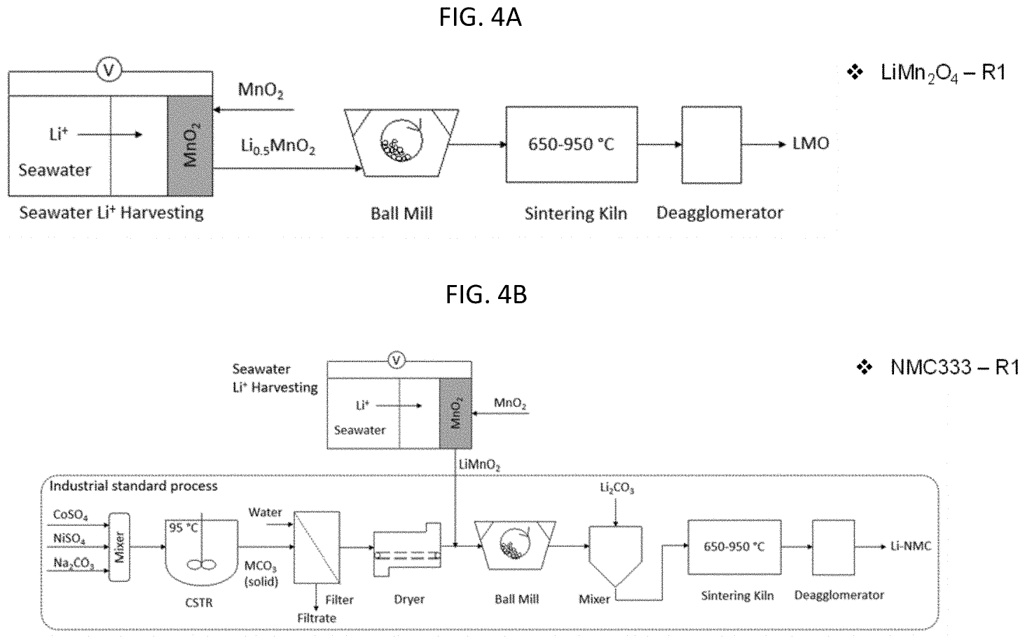

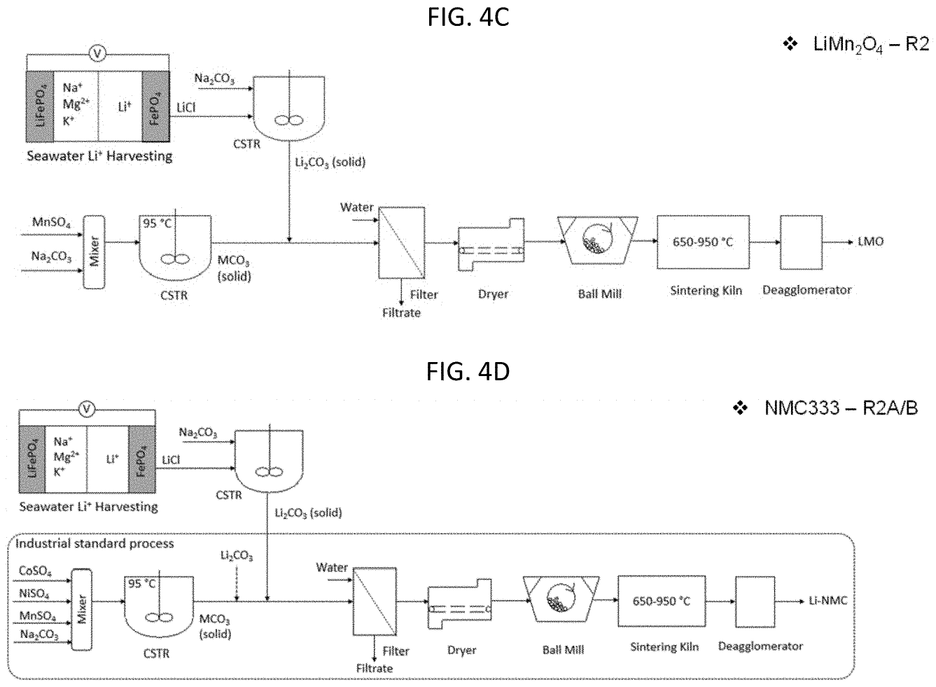

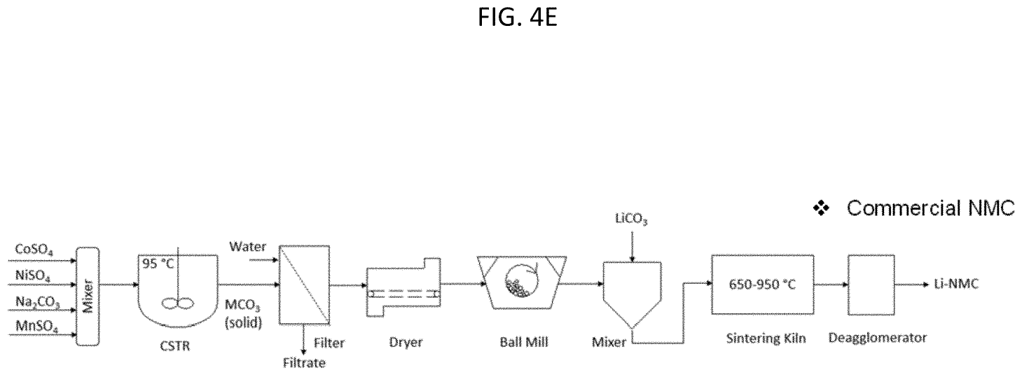

The Li and Mn of the harvested Li-EMD are precursor materials of many Li cathodes and thus can be used for direct cathode production. Depending on the target cathode formulas, the Li-EMD can be used as the sole precursor or mixed with additional transition metal or Li resources. For instance, Li_{0.5}MnO₂ can be processed through the extraction device by controlling Li intercalation content and then is used to prepared spinel LiMn₂O₄ by high-temperature calcination (FIG. 4A). Depending on the design of target cathode formula, the Li intercalation content in the EMD can be tuned from >0 to ≤2 mol Li per molar EMD (LiₓEMD, 0<x<2) through controlling the electrochemical extraction cutoff voltage. For another category of Li-ion cathodes layered transition metal oxides, taking LiNi_{1/3}Mn_{1/3}Co_{1/3} (NMC333) as an example, addition metal precursors of Ni and Co will be mixed with Li-EMD first, and then calcinated into the target cathode by controlling the heating temperature or atmosphere (FIG. 4B). FIGS. 3A-3C show the phase structure and morphology of the synthesized spinel LiMn₂O₄ and layered NMC333. The synthesized LiMn₂O₄ has a spinel cubic structure with space group Fd3m (FIG. 3A) and a diamond-shaped morphology with sharp edges (FIG. 3B), which are typically observed for the material. For NMC333, all the diffraction peaks can be indexed to layered hexagonal structure of α-NaFeO₂ with space group R-3m. Observation of the clear splitting of peak (006)/(012) and (018)/(110) indicates a well grown crystals with layered structures, which is consistent with the morphology characterization (FIG. 3C). The electrochemical properties of both cathodes were tested in coin cells by coupling with Li metal anode and organic electrolyte. The spinel LiMn₂O₄ exhibits a typical two-plateau charge/discharge profiles at with a reversible of 92.8 mAh/g at 0.1 C. The cell has an exceptional cycling stability in terms of capacity and discharging voltage at 0.33 C and demonstrates a capacity retention of 97.7% after 300 cycles. For NMC333, within a voltage range of 2.7-4.5 V, a reversible capacity of 139.4 mAh/g was obtained. The capacity retention at 0.33 C is 74.4% after 300 cycles. The obtained discharge specific capacities of LiMn₂O₄ and NMC333 are slightly lower than the commercial ones, which may be attributed to the complex of Li-EMD precursor, bringing hindrance for Li-ion diffusion kinetics. The capacity decay in NMC333 is associated with voltage drop, which is due to the exaggerated side reactions of materials with electrolyte caused by the small particle size. To improve the cycling stability for commercial cells, such small particles need to be remanufactured into large size secondary particles or big single-crystalline materials.

The methods and devices disclosed herein can provide high purity extracted Li. Owing to the high selectivity of the Li ion-selective membrane (e.g., Li_{1.5}Al_{0.5}Ge_{1.5}(PO₄)₃(LAGP) membrane), only Li ions are allowed to intercalate into the electrolytic manganese dioxide (EMD), and other impurity metal cations or H⁺ are fully blocked within the feed stream; thus, the resulted Li-EMD has a high chemical purity. For example, the co-intercalated metal cations like Na⁺, K⁺, Mg²⁺, Ca²⁺ etc are below 0.1 mol per molar EMD, or lower than 0.01 mol per molar EMD. The harvested Li and EMD host (Li-EMD) both are precursor materials of battery and can be directly used for cathode mass production after adding necessary elements, depending on the design of target cathode formulas (e.g. LiMnₓNi_{y}Co_{z}O₂, x+y+z=1). Since the absorbent regeneration and Li separation/purification, which have significant impacts on processing efficiency, energy consumption, and cost, are fully eliminated, this makes Li cathode production more cost competitive even compared with commercial ones. The Li extraction process can be realized by swapping the EMD cartridge at desired lithiation depth or after its full lithiation, thus simplifying automation in industry. Moreover, the environment impacts caused by chemical use and waste treatment associated with conventional precipitation processes are also avoided in the methods disclosed herein.

### Examples

Material Preparation

Li-EMD to Spinel LiMn₂O₄: Electrolytic manganese dioxide (EMD) is received from TRONOX. The lithiated EMD, named as Li-EMD, was obtained by electrochemical Li extraction technology. To synthesize spinel LiMn₂O₄, the lithium content (x) in LiₓMnO₂ was controlled less than 0.5 by adjusting the cutoff voltage during the 1^{st} discharge process. After the electrode was washed and dried out, the electrode material was scraped off with a blade and calcined in air at 500° C. for 4 h. Then the calcined powder was mixed with Li₂CO₃ to make sure the ratio between Li and Mn is 0.5. The mixture was grounded and pressed into pellet, and calcined at 900° C. for 12 h under oxygen atmosphere, the corresponding heating and cooling temperature were set as 5° C./min and 2° C./min Finally, a dark powder is obtained, which is spinel LiMn₂O₄.

Li-EMD to LiNi_{1/3}Co_{1/3}Mn_{1/3}O₂: Ni(NO₃)₂.6H₂O, Co(NO₃)₂.6H₂O and LiOH.H₂O were purchased from Sigma. The lithiated EMD powder was scraped off and mixed with Ni(NO₃)₂.6H₂O and Co(NO₃)₂.6H₂O in molar ratio of 1:1:1. Meanwhile, according to the lithium content in Li-EMD, a certain amount of LiOH.H₂O was added into the above solid mixture with the ratio of 1.04:1 [(Li_{Li-EMD}+L_{LiOH}):(Ni+Co+Mn)]. The 4 mol % excess lithium is used to compensate the Li loss during calcinating. The final mixture was grounded and pre-calcinated at 500° C. for 4 h, and then grounded in mortar, followed by heating at 900° C. for 6 h in air. The ramping rate was controlled at 5° C./min for both heating and cooling. The final dark powder is LiNi_{1/3}Co_{1/3}Mn_{1/3}O₂, labelled as NMC333.

Li_{1.5}Al_{0.5}Ge_{1.5}(PO₄)₃ synthesizing and characterization: Li_{1.5}Al_{0.5}Ge_{1.5}(PO₄)₃ (LAGP) material was obtained from Ampcera. The powder had a mean particle size of approximately 500 nm.

Disks were uniaxially pressed in a 31.7 mm die with 5000 lbs applied force (4087 psi or about 28 MPa) for 30 seconds. The resulting pellets were placed in an MgO tray and covered with sacrificial powder of the same composition. The tray was closed with an MgO lid. The samples were fired in air with a heating rate of 1° C./minute to 850° C., held for 4 hours, and cooled to room temperature at 5° C./minute. The prepared LAGP (25 cm in length) presents a very dense structure and uniform element distribution. Before testing, the interfacial stability between LAGP and applied electrolytes (SE/LE-interface), including organic and aqueous electrolytes, was measured by in-situ impedance. To exclude interference, one side of LAGP was coated with Au and connected with SS-rod, the other uncoated fresh side contacted with liquid electrolytes for stability evaluation. There are two semicircles. (FIGS. 1D, 1E) The high-frequency semicircle has not totally shown up under 1 MHz, which can be allocated to the intragrain transport resistance (R_{SE,bulk}) and intergrain transport resistance (R_{SE,gb}). The middle-frequency semicircle is related to the SE/LE-interface resistance. The ionic conductivity is around 1.49 mS/cm.

### Sample Characteristic

The morphology of the materials was studied by scanning electron microscopy (SEM, JSM-IT2000). The crystal structure of our synthesized materials before and after Li extraction were analyzed by X-ray diffraction (XRD, Rikagu MiniFlex 600) in a 2-theta range of 10°-80° using Cu Kα radiation operated at 40 kV and 15 mA. Li content in the materials was analyzed by ICP-OES spectrometers (Optima 7300 DV). TEM samples were prepared by dispensing the cathode particles onto TEM lacey carbon grids inside an Ar-filled glovebox. TEM imaging was conducted on a Titan 80-300™ scanning/transmission electron microscope operated at 300 kV. STEM EELS microanalysis data were collected on an aberration corrected JEOL GrandARM-300F with the operation voltage of 300 kV, and a post-column Gatan Image Filter (GIF) working at 0.25 eV/channel energy dispersion.

### Electrochemical Measurements

Three cell configurations were employed for the materials validation and technology demonstration, including traditional coin-cell, liquid/LAGP/liquid-electrolyte cell and 3-electrode cell.

Coin-cell configuration with sandwiched anode/separator/cathode structure was used for fast material evaluation, where organic based Li solution of 1M LiPF₆ in ethyl carbonate (EC) and ethyl methyl carbonate (EMC) (3:7 by weight), Li metal and active material (EMD, LiMn₂O₄ or NMC333) were used as electrolyte, anode, and cathode, respectively. EMD electrode was prepared by mixing electrode materials, PVDF and conductive carbon with a ratio of 80:10:10, and the mixing ratio in LiMn₂O₄ and NMC333 electrodes is 70:20:10.

The cell with LAGP is composed of multilayer structures, namely anode/aqueous-electrolyte/LAGP/organic-electrolyte/cathode, the corresponding aqueous electrolyte and organic electrolyte are Li-containing (5M LiCl) aqueous and 3M LiTFSI in EC/EMC (w/w=3:7). Stainless steel rod and EMD electrode were applied as anode and cathode, the corresponding EMD electrode loading is around 4 mg cm⁻².

In 3-electrode cell, we developed a solvent assisted solid processing method to prepare free-standing EMD electrode and control the electrode architecture without sacrificing electrode stability/durability. The free-standing EMD electrode was attached onto Ti mesh current collector), forming the Li extraction film electrode, and the corresponding counter electrode is Pt. The used reference electrodes are Ag/AgCl electrode (in aqueous) or Ag/Ag⁺ electrode (in organic electrolyte). The testing voltage in three-electrode cell was set between open circuit voltage (OCV) and −0.54 V, and the corresponding current density is 0.1 C (1 C=200 mA/g).

In view of the many possible embodiments to which the principles of the disclosed invention may be applied, it should be recognized that the illustrated embodiments are only preferred examples of the invention and should not be taken as limiting the scope of the invention.

What is claimed is:

1. A method comprising:
contacting a Li-containing aqueous liquid with a Li ion-selective membrane while simultaneously applying an electric field thereby extracting Li ions from the Li-containing aqueous liquid; and
intercalating the extracted Li ions into a cathode material.

2. The method of claim 1, wherein the cathode material comprises MOₓ, MF_{y}, or MS_{z}, where M=Ti, V, Cr, Mn, Fe, Co, Ni, Cu, Zn, Zr, Nb, Mo, Si, Ge, Sn, Pb, P, As, Sb; 0≤x≤4; 0≤y≤6; and 0≤z≤4, and the Li-containing aqueous liquid is seawater, a brine, an underground source of concentrated salt water, a Li-recycle solution, or an industry waste.

3. The method of claim 1, wherein the cathode material comprises an electrolytic manganese dioxide.

4. The method of claim 1, further comprising passing the extracted Li ions through a nonaqueous liquid electrolyte prior to intercalating the extracted Li ions into the cathode material.

5. The method of claim 3, further comprising passing the extracted Li ions through a nonaqueous liquid electrolyte prior to intercalating the extracted Li ions into the electrolytic manganese dioxide.

6. The method of claim 1, wherein the applied electric field has a voltage of −2V to 3V vs. SHE.

7. The method of claim 3, wherein the Li-containing aqueous liquid is seawater, a brine, an underground source of concentrated salt water, a Li-recycle solution, or an industry waste.

8. The method of claim 3, wherein the Li-containing aqueous liquid is seawater.

9. The method of claim 3, wherein the Li-containing aqueous liquid is brine.

10. The method of claim 3, wherein the Li-containing aqueous liquid is geothermal brine.

11. The method of claim 3, wherein the Li-containing aqueous liquid is a Li-recycle solution.

12. The method of claim 3, wherein the Li-containing aqueous liquid is industry waste solution.

13. The method of claim 1, wherein the Li ion-selective membrane comprises LiAB(PO₄)₃ (A=Al, Cr, Ga, Fe, Sc, In, Lu, Y, or La; B═Ge, Ti or Zr), perovskite-type lithium lanthanum titanate, LISICON structure, Li₅La₃M₂O₁₂ (M=Ta, Nb), Li₆ALa₂M₂O₁₂ (A=Ca, Sr, Ba), or Li₅Ln₃Sb₂O₁₂ (Ln=La, Pr, Nd, Sm, or Eu).

14. The method of claim 1, wherein the Li ion-selective membrane comprises Li_{1.5}Al_{0.5}Ge_{1.5}(PO₄)₃.

15. The method of claim 5, wherein the nonaqueous liquid electrolyte comprises at least one active salt and at least one solvent

16. The method of claim 15, wherein the active salt is lithium bis(fluorosulfonyl)imide (LiFSI), lithium bis(trifluoromethanesulfonyl)imide (LiTFSI), lithium bis(pentafluoroethanesulfonyl)imide (LiBETI), lithium bis(oxalato)borate (LiBOB), LiPF₆, LiAsF₆, LiBF₄, LiCF₃SO₃, LiClO₄, lithium difluoro oxalato borate (LiDFOB), LiI, LiBr, LiCl, LiSCN, LiNO₃, LiNO₂, or Li₂SO₄.

17. The method of claim 15, wherein the solvent is an alkyl carbonate, an ether, or an ester.

18. The method of claim 3, wherein the Li-intercalated electrolytic manganese dioxide has a Li content of from >0 to ≤2 mol Li per molar electrolytic manganese dioxide.

19. The method of claim 3, further comprising producing a battery cathode material from the Li-intercalated electrolytic manganese dioxide substrate.

20. The method of claim 19, wherein the battery cathode material comprises spinel LiMn₂O₄, LiMnₓNi_{y}Co_{z}O₂ (wherein x+y+z=1), LiMPO₄ (M=Mn, Fe, Ni, Co or their mixture), or Li₂MSiO₄ (M=Mn, Fe, Ni, Co or their mixture).

21. A method comprising:
introducing a Li-containing aqueous liquid into a first chamber of a device, wherein the device comprises an anode, a cathode comprising electrolytic manganese dioxide, a Li ion-selective membrane between the anode and the cathode, the first chamber contacting the anode a first surface of the Li ion-selective membrane; and a second chamber contacting the cathode and a second surface of the Li ion-selective membrane, wherein the second chamber contains a nonaqueous liquid electrolyte;
applying an electric field to the device;
permitting Li ions to selectively flow through the Li ion-selective membrane and into the second chamber; and
intercalating the extracted Li ions into the electrolytic manganese dioxide.

22. The method of claim 21, wherein the Li-containing aqueous liquid is seawater, a brine, or a Li-recycle solution; the Li ion-selective membrane comprises Li_{1.5}Al_{0.5}Ge_{1.5}(PO₄)₃; the nonaqueous liquid electrolyte comprises at least one active salt and at least one solvent, wherein the active salt is lithium bis(fluorosulfonyl)imide (LiFSI), lithium bis(trifluoromethanesulfonyl)imide (LiTFSI), lithium bis(pentafluoroethanesulfonyl)imide (LiBETI), lithium bis(oxalato)borate (LiBOB), LiPF₆, LiAsF₆, LiBF₄, LiCF₃SO₃, LiClO₄, lithium difluoro oxalato borate (LiDFOB), LiI, LiBr, LiCl, LiSCN, LiNO₃, LiNO₂, or Li₂SO₄; and the solvent is an alkyl carbonate, an ether, or an ester.

23. A device comprising:
an anode;
a cathode comprising electrolytic manganese dioxide;
a Li ion-selective membrane between the anode and the cathode;
a first chamber contacting the anode a first surface of the Li ion-selective membrane; and
a second chamber contacting the cathode and a second surface of the Li ion-selective membrane.

24. The device of claim 23, wherein the anode comprises stainless steel, nickel, titanium, tungsten, carbon, or graphite.

25. The device of claim 23, wherein the Li ion-selective membrane comprises LiAB(PO₄)₃ (A=Al, Cr, Ga, Fe, Sc, In, Lu, Y, or La; B═Ge, Ti or Zr), perovskite-type lithium lanthanum titanate, LISICON structure, Li₅La₃M₂O₁₂ (M=Ta, Nb), Li₆ALa₂ M₂O₁₂ (A=Ca, Sr, Ba), or Li₅Ln₃Sb₂O₁₂ (Ln=La, Pr, Nd, Sm, or Eu).
